(19) United States
(12) Patent Application Publication
(10) Pub. No.: US 2002/0069033 A1
(43) Pub. Date: Jun. 6, 2002

(54) Method for determining measurement error for gene expression microarrays

(76) Inventors: David M. Rocke, Davis, CA (US); Blythe P. Durbin, Davis, CA (US)

Correspondence Address: McCutchen, Doyle,, Brown & Enersen, LLP, 28th Floor, Three Embarcadero Center, San Francisco, CA, 94111, US

(21) Appl. No.: 09/955,663

(22) Filed: Sep. 19, 2001

Related U.S. Application Data
(60) Provisional application No. 60/233,547, filed on Sep. 19, 2000.

(51) Int. Cl. G06F 15/00; G06F 101/14

(52) U.S. Cl. 702/179

(57) ABSTRACT

Quantitative methods for analyzing measurement errors from nucleic acid arrays are provided. The methods are based on a two component model that approximates a constant standard deviation for very low expression levels, and constant relative standard deviation (RSD) for higher concentrations. Estimates of some model parameters may be obtained without resort to replicated measurements. Also provided are thresholding methods for establishing boundaries between low expression levels, high expression levels, and intermediate expression levels, and methods for estimating actual expression levels from intensity measurements.

### CROSS-REFERENCE TO RELATED APPLICATIONS

This application claims the benefit of U.S. Provisional Patent Application No. 60/233,547, filed Sep. 19, 2000, the contents of which are hereby incorporated by reference for all purposes.

### STATEMENT REGARDING FEDERALLY SPONSORED RESEARCH

The United States Government has rights in this invention pursuant to Contract No. P42 ES 04699 between the National Institute of Environmental Health Sciences and the University of California.

### FIELD OF THE INVENTION

The invention relates to the field of error analysis, and more specifically to analysis of errors in the measurement of nucleic acid array data.

### BACKGROUND OF THE INVENTION

The human genome project will, at its conclusion, provide a complete description of the entire human genome sequence. Applications of such sequence information to diagnostics, prognostication, and basic research problems already are occurring. In addition to genomic sequence information becoming available through the efforts of gene sequencers working under the auspices of the human genome project, cDNA sequences also are widely available. Such sequences represent expressed genes actively transcribed and translated in cells. High density oligonucleotide arrays, such as the GeneChip® arrays manufactured by Affymetrix, can be manufactured once genomic or cDNA sequences are determined. These and other similar arrays provide a convenient way to sequence genomic DNA from an individual (i.e., to genotype) and to monitor gene expression. The data produced by hybridizing samples to these and other similar arrays allows scientists and clinicians to accomplish a number of objectives. For example, the developing field of pharmacogenomics relies on correlations made between drug response and genotype, enabling clinicians to predict which drug will best work in a patient. Similarly, by analyzing cDNA expression patterns, clinicians are improving their ability to distinguish among closely related diagnoses, and to monitor patient response to drug therapy.

Thus, DNA microarray technology has rapidly revolutionized research in the biological and medical fields. In the case of cDNA microarrays, the strength of the technology lies in its ability to allow the simultaneous monitoring of thousands of gene expressions in a single experiment (i.e., in a single sample). Applications to cancer research (DeRisi et al., Dec. 1996, Hilsenbeck et al., Jan 1999), acute leukemia (Golub et al., Oct. 1999), lymphoma (Ash et al., Feb. 2000), human cancer cell lines (Ross et al., March 2000), and colon tissues (Alon et al., June 1999) are some examples. Due to the explosion of the uses of microarrays, continued attempts to address management (Ermolaeva et al., Sept. 1998) and analysis (Chen et al., Oct 1997, Eisen et al., Dec. 1998, Newton et al., 2000) of gene expression data are needed. The present invention addresses the need for improved methods for analysis of microarray-derived gene expression data by providing methods for determining the precision of such data over the full range of observed expression levels. While the methods are described with specific reference to expression arrays, they are equally applicable to other data having similar structure, as described below.

### BRIEF SUMMARY OF THE INVENTION

Methods are provided for determining the precision of data obtained from nucleic acid arrays, including gene expression microarrays, over a range of signal levels. The data are analyzed according to the following model:

y=α+μeⁿ+ε Equation 1

where y is the observed intensity measurement, μ is the expression level in arbitrary units, α is the mean background (mean intensity of unexpressed genes), η, the proportional error that always exists, but is noticeable at concentrations significantly above zero, and ε, represents an additive error that always exists, but is noticeable mainly for near-zero concentrations.

One aspect of the method involves application of a thresholding algorithm to identify the set of data comprising “low” signal level data, i.e., data with observed signal intensities below a threshold cutoff determined according to the thresholding algorithm. Two parameters are estimated from this set of data. One is α, corresponding to the above-described mean background intensity (i.e., the mean intensity of unexpressed genes) The other is the standard deviation, σ_{ε}, of the additive error, ε, that is always present, but is noticeable mainly for near-zero concentrations. These parameters may be estimated even in the absence of replicate measurements. Alternatively, α and σ_{ε} may be estimated from negative control experiments, i.e., replicate blanks.

Replicated measurements of high expression level signals (i.e., measurements for which the variance of the logarithms of the signal is approximately constant) are used to estimate σ_{η}.

The present invention uses these parameters to provide estimates of the variance of the measured intensity, and other statistical measures such as confidence limits of the expression levels, expressed in arbitrary units.

### DESCRIPTION OF THE DRAWINGS

FIG. 1 illustrates cutoff points for 72 arrays.

FIG. 2 illustrates expression values in a single array with horizontal line showing cutoff point at convergence of thresholding algorithm.

FIG. 3 is a Table illustrating cutoff points at convergence.

### DETAILED DESCRIPTION OF PREFERRED EMBODIMENTS

1. Introduction

Just as with any other analytical technology, measurement of gene expression with cDNA or other oligonucleotide arrays have associated measurement errors. It is commonly observed that the standard deviation of measurements rises in proportion to the expression level. However, this proportionality cannot continue down to genes that are entirely unexpressed because that would imply zero measurement error, which is not observed. The model proposed in this patent (Equation 1) originally was developed in the context of instrumental methods of analytical chemistry, because these methods also exhibit the same kind of behavior referenced above (Rocke and Lorenzato, 1995).

The model used in the present invention resolves the difficulties of determining cDNA expression level measurement errors by incorporating both types of error observed in practice into a single model. The model provides advantages over existing models by describing the precision of measurements across the entire usable range of observed signal intensities. Applications of the model developed in the present invention pertain to detection limits, categorization of genes as expressed or unexpressed, comparison of gene expression under different conditions, sample size calculations, construction of confidence intervals, and transformation of expression data for use in multivariate applications such as classification or clustering.

2. The Model

Most measurement technologies require a linear calibration curve to estimate the actual concentration of an analyte in a sample for a given response. We can incorporate into the linear calibration model the two types of errors that are observed in most analyses. The two-component model for analytical methods such as gas chromatography/mass spectrometry (“GC/MS”) is:

y=α+βμe^{η}+ε Equation 2

where y is the response of the measuring apparatus (such as peak area) at concentration μ, η˜N(0,σ_{η}²) (i.e., η is a random variable that is normally distributed around a mean of zero, and that has a variance, σ_{η}²), and ε˜N(0,σ_{ε}²) (i.e., ε is a random variable that is normally distributed around a mean of zero, and that has a variance, σ_{ε}²). Here, η represents the proportional error that always exits, but is noticeable at concentrations significantly above zero, and ε represents the additive error that always exists but is noticeable mainly for near-zero concentrations. β represents a slope factor that relates response, y, to concentration, μ, and can be determined through the use of a calibration curve constructed using standards of known concentration. α represents mean background, i.e., the mean response, y, obtained by running blanks through the analysis system. This two-component model approximates a constant standard deviation for very low concentrations and approximates a constant relative standard deviation (“RSD”) for higher concentrations.

For gene expression arrays, it is unusual to have calibration data (that is samples of known expression levels), since constructing a spiked sample for thousands of genes would be prohibitively complex. Thus, we cannot actually discern the expression level in molecular units, but can only do so relatively. The model for gene expression arrays therefore looks like this:

y=α+μe^{η}+ε Equation 1

where y is the intensity measurement, μ is the expression level in arbitrary units, α is the mean background (mean intensity of unexpressed genes), η is the proportional error that always exists, but is noticeable at expression levels significantly above zero, and ε represents the additive error that always exists but is noticeable mainly for near-zero expression levels.

Under this model, the variance of the response y at concentration μ is given by:

Var{y}=μ²e^{σ}^{_{η}}^{²}(e^{σ}^{_{η}}^{²}−1)+σ_{ε}² Equation 3

(Rocke and Lorenzato 1995). A derived quantity will be useful in interpretation of the results.

$${S}_{η} = \sqrt{{e}^{{σ}_{η}^{2}} ( {e}^{{σ}_{η}^{2}} - 1 )} \qquad Equation 4$$

S_{η} is the approximate relative standard deviation (“RSD”) of y for high levels.

Using this derived quantity, we can represent the variance of y as

Var{y}=μ²S_{η}²+σ_{ε}² Equation 5

3. Estimation

The parameters in the two-component model can be estimated in a number of ways. The easiest way to estimate the standard deviation σ_{ε} of the low level measurements is from replicate blanks (negative controls). Data are generated using an array identical to the array on which samples will be run, and a blank (comprising components identical to the sample components in all ways except for the presence of sample nucleic acid, which is omitted from the blank) is loaded onto the array, and processed in a manner identical to the procedures used with an actual sample. In some instances, it is possible to use the same array sequentially for obtaining negative control and sample data. For example, if processing the array used for the negative control does not impair the ability to obtain data from a subsequently run sample, then the same array can be used for the negative control and the sample. Of course, this procedure will be of value only if the data obtained from the subsequently run sample is statistically the same as the sample data that would have been obtained had the negative control not first been run on the array.

One of ordinary skill will readily appreciate how to evaluate whether first running a negative control alters the subsequently obtained sample data in a statistically significant manner. By way of example, an experiment can be set up using two sets of arrays that are purported to be identical (i.e., arrays from a single manufacturing lot). One set is used to generate sample data without pre-running a negative control on the arrays, while the other set is used to generate negative control data, and then, on the same arrays, to generate sample data. If pre-running negative controls on the arrays does not impair the ability to obtain data from a subsequently run sample, then comparisons of the intensity levels between the two sets should reveal that they are statistically unchanged from each other.

The standard deviation of the negative controls is an estimate of σ_{ε}. The mean intensity of the negative controls is a suitable estimate of α, the mean background. In the next section, we present a method of estimating α and σ_{ε} even from unreplicated data through the use of thresholding algorithms. The parameter σ_{η} can be likewise estimated from the standard deviation of the logarithm of high level replicated measurements. High level measurements may be assumed to be the highest intensity measurements, i.e., the set of the several highest intensity measurements. As described below, the set of high level measurements is characterized by the fact that the variance of the logarithms of these measurements is constant. This characterization may be used to check whether a set of replicated measurements should be included within the set of high level measurements. Ideally, such replicated measurements arise from identical probe areas on a single chip, although, as described below, such replicated measurements might be obtained through the use of a plurality of chips run with identical samples, provided that appropriate scaling is used to normalize the intensities among the plurality of chips.

For each replicated gene that is expressed at a high level, compute the standard deviation sᵢ of the logarithm of the replicates. If there are m replicated genes, one then pools these estimates as follows:

$$s = \sqrt{{( n - m )}^{- 1} {\sum }_{i = 1}^{m} {s}_{i}^{2} ( {n}_{i} - 1 )} \qquad Equation 6$$

where nᵢ is the number of replicates for gene i and

$$n = {\sum }_{i = 1}^{m} {n}_{i} \qquad Equation 7$$

The parameter, s, obtained from Equation 6 is an estimate of σ_{η}. Thus, S_{η} can be estimated by squaring s, obtained from Equation 6, and substituting s² in place of σ_{η}² in Equation 4.

This method of estimating σ_{η} works because for high expression levels, Equation 1 is indistinguishable from

y=μe^{η} Equation 8

1n(y)=1n(μ)+η Equation 9

which is a constant mean, constant variance model.

There is no method even in principle for estimating measurement error without at least some replication at high levels since it is impossible from an unreplicated sample to know if an intensity value is high because the expression is high or because of a positive measurement error. This fact of life should be an important determinant of experimental design in microarrays.

If there are no negative controls, σ_{ε} can be estimated by pooling the variance estimates of genes that have low expression levels. For this, one would use the raw expression values and not the logarithms. The definition of high and low expression is, of course, dependent on the values of the parameters σ_{ε}² and S_{η} For example, the variance of y given by Equation 5 can be compared with the variance of y at low expression levels, where the primary source of variance derives from the variance of the additive error component, i.e., σ_{ε}². We can define a threshold expression level for low-level expression as that expression level at which at least 90% of the observed variance in y arises out of the variance of the additive error component, i.e, σ_{ε}². Mathematically, this can be expressed as follows:

$$\frac{{σ}_{ϵ}^{2}}{{σ}_{ϵ}^{2} + {μ}^{2} {S}_{η}^{2}} \geq 0.9 \qquad Equation 10$$

Cross multiplying Equation 10 gives rise to:

σ_{ε}²≧0.9σ_{ε}²+0.9μ²S_{η}² Equation 11

Collecting similar terms and dividing through by 0.9S_{η}² yields:

$${μ}^{2} \leq \frac{0.1 {σ}_{ϵ}^{2}}{0.9 {S}_{η}^{2}} \qquad Equation 12$$

Taking the square root of the Equation 12 gives us:

μ≦σ_{ε}/3S_{η} Equation 13

Thus, one can define “low-level” data as those data where the observed expression, μ, is less than or equal to the threshold defined as σ_{ε}/3S_{η}.

Similarly, “high-level” data can be defined according to a threshold above which at least 90% of the observed variance in y arises from the variance of the proportional error component, i.e., μ²S_{η}². This is mathematically expressed as:

$$\frac{{μ}^{2} {S}_{η}^{2}}{{σ}_{ϵ}^{2} + {μ}^{2} {S}_{η}^{2}} \geq 0.9 \qquad Equation 14$$

Using the same algebraic re-arrangements as described above, we arrive at the threshold μ for high-level data as follows:

μ²S_{η}²≧0.9σ_{ε}²+0.9μ²S_{η}² Equation 15

$${μ}^{2} \geq \frac{0.9 {σ}_{ϵ}^{2}}{0.1 {S}_{η}^{2}} \qquad Equation 16$$

μ≧3σ_{ε}/S_{η} Equation 17

Thus, one can define “high-level” data as ones where the observed expression, μ, equals or exceeds the threshold defined as 3σ_{ε}/S_{η}. Note that once an estimate has been obtained for S_{η} from the an initial set of high level replicated measurements, the high-level threshold Equation 17 can be used to check whether each replicate comprising the set exceeded the threshold. If some of the data are found to be below the threshold, they can be discarded from the set, s and S_{η} can be recalculated and the new data set used to calculate these parameters can be rechecked against Equation 17. This procedure can be iterated until each member of the set of high level replicated measurements meets or exceeds the high-level threshold as set out in Equation 17.

As an example, suppose that the background had mean α=10 and standard deviation σ_{ε}=1, and the high level coefficient of variation, S_{η}=0.1. Then, applying Equation 13 we obtain the threshold of low-level measurements, for which the standard deviation would be approximately constant, as those measurements for which the expression level μ≦(1)/(3)(0.1)=3.33 (i.e., μ≦3.33), corresponding to intensity values less than or equal to 13.33 (i.e., the background, α, plus μ). Note that this is slightly greater than three standard deviations of the background above mean background; i.e. 3σ_{ε}+α=(3)(1)+10=13.

High-level measurements, corresponding to measurements with nearly constant coefficient of variation, for which logarithms should stabilize the variance, are those for which the conditions of Equation 17 apply, i.e.,μ≧3σ_{ε}S_{η}=(3)(1)/(0.1)=30(i.e. μ≧30), corresponding to intensities greater than or equal to 40. In the range 13.33 to 40, both the variance and the coefficient of variation are changing drastically.

For data with calibration curves, the most effective estimation method is maximum likelihood, as described in Rocke & Lorenzato (1995), but the more heuristic methods alluded to above may be satisfactory for many applications.

4. Estimation of Background Without Replication

According to Equation 1, intensity measurements from unexpressed genes will be normally distributed with mean α and standard deviation σ_{ε}. If there were a defined set of negative controls, then their mean and standard deviation would be estimates of these parameters. In the absence of negative controls, the following thresholding algorithm procedures are recommended. The algorithms may be used in conjunction with some current data preprocessing and thresholding. The algorithms converge to a “cutoff point” for p gene expressions on a given array. The analyst can then decide to analyze genes with expression measurements above this cutoff point, or use the information from the algorithms for array rescaling.

The use of thresholding is common in the analysis of gene expression data. For example, gene expression levels that fall below a certain threshold level are deleted from analysis; this may be justified under some prior knowledge about the experimental procedure, otherwise such practice is arbitrary. It is also common practice to discard negative measurements (which occurs when a spot background noise measurement exceeds the signal intensity). Although negative measurements (due to imperfect measurement technology) should not be used in the analysis of gene expression, this information can be used to estimate the array-specific noise for rescaling. It also has been suggested that genes exhibiting at least k-fold (e.g., 3-fold) changes in differential expressions in cDNA arrays (i.e., comparing expression between two different samples) are deemed significant and such rules appear somewhat arbitrary as well. A study of differential variability of expression ratios suggests some alternatives (Newton et al., 2000). The described thresholding algorithms find a “cutoff” point for each array (hence accounting for different levels of noise specific to individual arrays). Genes with expression levels below the cutoff point may be considered unreliable or this information can be used as an estimate of “noise’ for that particular array; an estimate of array-specific noise can also be used to scale the arrays. Scaling can be used to provide “replicated” data sets when aliquots of a sample are run on a plurality of arrays. As described above, such replicated data currently are needed to provide estimates of σ_{η}.

The thresholding algorithms have two parameters: (a) the percentage (q) of the smallest expression values in the array to form the initial set, and (b) the number of standard deviations, σ, or median absolute deviations (MAD) above the mean or median to determine the cutoff point. We refer to the second parameter as (c). These thresholding algorithms can be applied separately for treatment and control in a two-color array. The algorithms are robust to outlying observations, and are not sensitive to the first parameter, q. A general description of the algorithms follows, starting with the algorithm that uses the mean and standard deviation to compute the cutoff point.

1. Begin with a small subset of genes with low intensity, such as q=the 10% of genes with lowest intensity measurements. Compute the mean μ_{B} and the standard deviation σ_{B} of these genes.

2. Define a new subset consisting of genes whose intensity values are no larger than μ_{B}+3σ_{B}(i.e. c=3). Recompute μ_{B} and σ_{B}.

3. Repeat the previous step until the set of genes does not change.

At the final step, the set of genes should include at least 99.9% of the unexpressed genes. Depending on the distribution of actual expression levels, this estimate could be biased up both in mean and the standard deviation, because it is impossible in principle to distinguish an unexpressed gene from one with such a low expression level that it is below detection limits. Nonetheless, this estimate should be of considerable use in screening genes for expression.

The MAD-based variant of this procedure may reduce the bias somewhat. In this variant, one uses the median of the expression levels of the subset of genes as the estimate of location, and uses MAD/0.6745 as the estimate of σ_{B}, where the MAD is the median absolute deviation from the median. This is calculated by subtracting the median from each expression value in the subset, taking absolute values, and taking the median of the resultant set of absolute deviations.

A more formal mathematical description of the MAD-based variant is described below. Of course, this description also pertains to the mean and standard-deviation based algorithm, by substituting the mean for the median, and the standard deviation, σ, for the MAD.

Let the original gene expression values for the ith array be x₁, x₂, . . . , xₚ and i=1, 2, . . . , N is the number of arrays. For brevity of notation denote the collection of expression values for array i by {xⱼ}ⱼ₌₁^{p} and assume that these values are sorted {xⱼ}ⱼ₌₁^{p}←sort({xⱼ}ⱼ₌₁^{p}.

5. Parameters q and c

1. Select a percentage, q% of the total number of genes, having the lowest expression values. Denote this initial set of values by A₀={x₁, x₂, . . . , xₙₒ}.

2. Calculate the median of the initial set, mₒ=median {xⱼ}ⱼ₌₁ⁿ^{ₒ}.

3. Calculate the median of the absolute deviations about the median, MAD₀=median {|xⱼ−mₒ|}ⱼ₌₁ⁿ^{ₒ}, of the initial set of values A₀.

4. Calculate the cutoff point, u₀=MAD₀+c×sₒ, where sₒ=MAD₀/0.6745 and c=2, 2.5, or 3 (i.e., the number of median absolute deviations above the median).

5. Determine the new set defined by A₁={all xⱼ<u₀}.

6. Repeat steps 2 through 5 (for each new set Aₖ) and stop when nₖ=nₖ₋₁ (convergence). At convergence denote the set of expression levels by Aₙ_{ᵢ} (with size nᵢ) and the cutoff point by uᵢ (i=1, 2, . . . , N).

7. Repeat steps 1 through 6 for each array, i=1, . . . , N.

In constructing the sets Aₖs we have used the median and MAD (median absolute deviation from the median) which are robust measures of location and dispersion, respectively. These measures are less affected by “extreme” observations. A measure of dispersion analogous to the well known sample standard deviation (σ) is s=MAD/0.675. However, the latter is a robust estimate and measures the dispersion of the central portion of data; the sample standard deviation may be heavily influenced by outliers, depending on the magnitude of the deviation of the outliers from the sample mean. This parameter, s, was used to determine the upper limit u=m+c×s in the algorithm (where m is the median). At convergence, the smallest nᵢ values of array i are selected as “noise” values. Estimates of the mean or median array-specific noise can be obtained by taking the sample mean or median of the set Aₙ_{ᵢ} for array i. Of course, any other statistics based on Aₙ_{ᵢ} also may be used to estimate array-specific noise.

6. Applications of the Thresholding Algorithms

As an illustration, one can use Aₙ_{ᵢ} to rescale the expression levels in array i. Suppose that the mean of

$${A}_{{n}_{i}} , \overline{{x}_{i}} = {\sum }_{j = 1}^{{n}_{i}} {x}_{ij} / {n}_{i} ( i = 1 , 2 , … , N )$$

is used. One may consider (a) multiplicative rescaling: xᵢⱼ←xᵢⱼmᵢ or (b) subtractive rescaling: xᵢⱼ←xᵢⱼ−aᵢ, where mᵢ={double overscore (xᵢ)}/\overline{xᵢ}, and {double overscore (xᵢ)} is the overall mean of the ith array. Other scaling choices are certainly possible. For an array with high average noise, using strategy (a) the rescaled expression measurements would be smaller relative to the expression values of another array with lower average noise (and similar overall average expression). Even baseline or control arrays are susceptible to errors since measurements come from the same system; hence, the algorithm can be applied here as well. As indicated above, such resealing can be used to combine data from different arrays, and in instances in which aliquots of the same sample are run on a plurality of identical arrays, the combined data can be used to generate the replicate measurements needed to estimate σ_{η}.

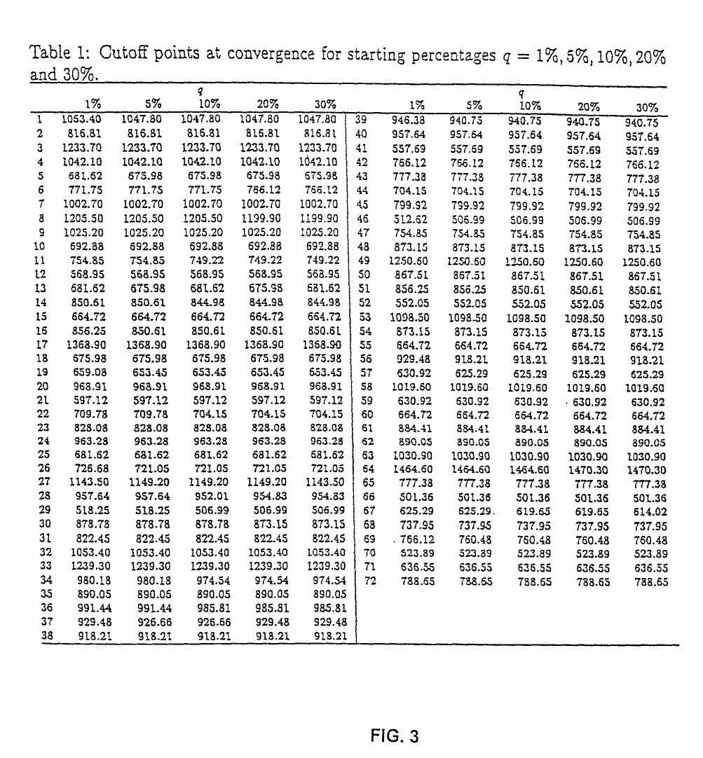

Some natural questions arise regarding the parameters (q and c) of the thresholding algorithms described above. For instance, one may specify that 10% (q=10) of the expression values of the ith array be used to form the initial set A₀. Will the set at convergence Aₙ_{ᵢ} be the same if q is changed, i.e., the initial set A₀ is changed? We provide some evidence to support that the sets Aₙ_{ᵢ}s at convergence is insensitive to the starting percentage q. Golub et al. (1999) considered molecular classification of acute leukemia based on a 38 samples training dataset and a 34 samples test data set. Samples were obtained from bone marrow and peripheral blood of acute leukemia patients. RNA was hybridized to high-density oligonucleotide microarrays (Affyrnetrix) with probes for 6,817 human genes. The MAD thresholding algorithm was applied to each of the 72 arrays with different starting percentages (q) of 1%, 5%, 10% and 20% (with c=3). The resulting cutoff points at convergence were the same (for the various qs) and only a few differ by negligible amounts (see Table 1, i.e., FIG. 3).

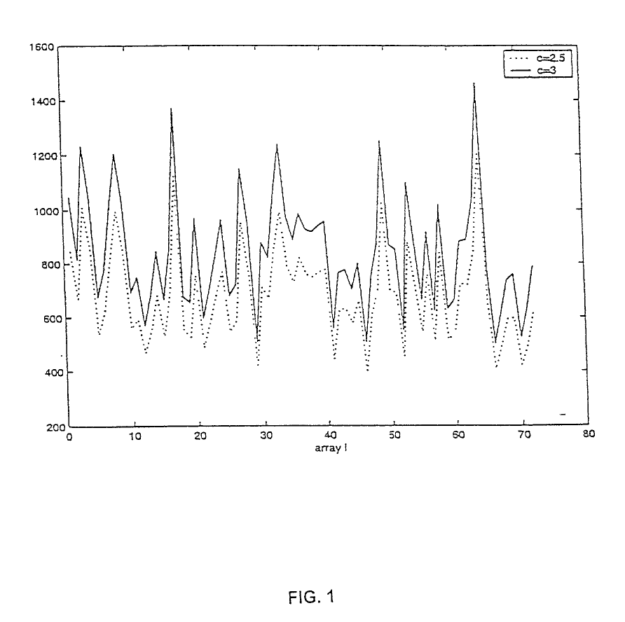

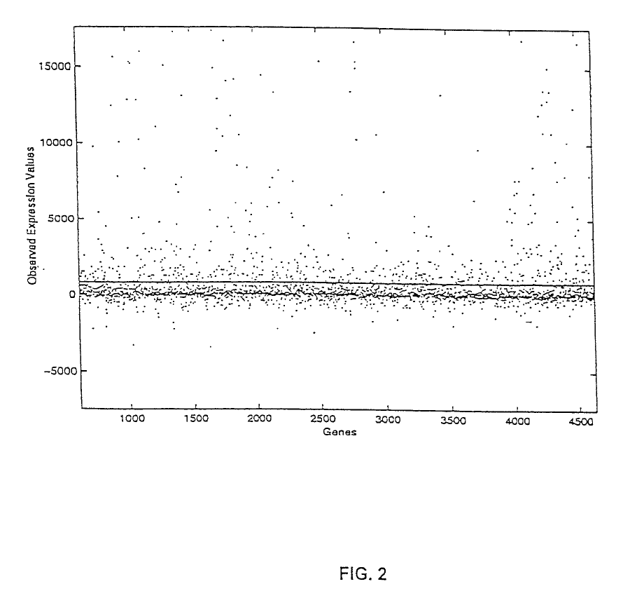

An implicit assumption in developing the threshold algorithm is that small expression values are the noise values; however, “small” is relative to the array. That is, the noise level is array specific. The question is how small is small for each array? The answer is the cutoff u at convergence, which separates noise values from “real” expressed values. This depends on the parameter c, the number of median absolute deviations above the median (or the number of standard deviations above the mean, depending on which version of the algorithm is used). Increasing c corresponds to a more stringent standard, since expression values must be larger to be excluded from the noise set. Since the resulting cutoff point does not depend on q, we set q=10% and ran the MAD thresholding algorithm for c=2.5 and 3. The results are given in FIG. 1. Also evident from FIG. 1 is that estimates of array-specific noise are quite variable, therefore, it may not be optimal the use a single threshold value across all arrays. FIG. 2 shows the expression values in a single array and the horizontal line is the cutoff point at convergence.

Although the example given here consists of high-density oligonucleotide arrays, the threshold algorithms can be applied to cDNA arrays as well. Assume that after background subtraction we have intensity measurements for the red-fluorescent dye Cy5 and another for the green-fluorescent dye Cy3 for the ith array. One strategy is to apply the above procedure to each set of dye measurements separately. After separate rescaling based on separate noise estimates for each channel, one can proceed to analyze the log (Cy5/Cy3) (positive) measurements. The reason for the separate applications of the threshold algorithm to the sets of measurements from different channels is that noise may be channel-specific.

7. Uncertainty of a Single Measurement

The uncertainty of a single measurement usually is quantified using confidence intervals. There are two primary approaches to this problem, an exact solution, and a normal or lognormal approximation. The exact solution requires numerical integration, as taught by Rocke and Lorenzato (1995) and will not be discussed here. Say we would like a 95% confidence interval for μ based on a single measurement, \hat{μ}. The approximate method for low values of \hat{μ}, (i.e., those in which the first term of Vâr(\hat{μ}) dominates) using an estimated variance and a normal approximation is:

\hat{μ}±1.96{square root over (Var(\hat{μ})}) Equation 18

where Vâr(\hat{μ}) is estimated using:

Vâr(\hat{μ})=\hat{σ}_{ε}²+\hat{μ}²e^{\hat{σ}}^{_{η}}^{²}(e^{\hat{σ}}^{_{η}}^{²}−1) Equation 19

which is, of course, equal to:

Vâr(\hat{μ})=\hat{σ}_{ε}²+\hat{μ}²Ŝ_{η}² Equation 20

where all estimates are obtained from the maximum likelihood routines such as those described in Rocke and Lorenzato (1995), or through the use of the heuristic estimation methods described above. For high levels of \hat{μ} (i.e., those in which the second term in Vâr(\hat{μ}) (as set out in Equation 19) dominates, 1n \hat{μ} is approximately normally distributed with variance σ_{η}². Hence a 95% confidence interval for μ is

(exp(1n\hat{μ}−1.96\hat{σ}_{η}), exp(1n\hat{μ}+1.96\hat{σ}_{η})) Equation 21

Note that this interval is symmetric on the log scale, but asymmetric on the original measurement scale.

We can also use this method to give confidence intervals for the average of a series of replicate measurements. For low levels, the average of r measurements will be approximately normally distributed with standard deviation

$$\sqrt{Var ( \hat{μ} ) / r} .$$

For larger values of \hat{μ}, the average of the natural log of the r measurements will have approximate standard deviation σ_{η}/\sqrt{r}. Confidence intervals can then be constructed as above, using the appropriate standard deviations.

All of the references to publications, patent applications or issued patents contained in this specification are herein incorporated by reference in their entirety for all purposes. The foregoing description is intended to illustrate the invention, but not to limit it. Variations and equivalents may be practiced by those of ordinary skill in the art without departing from the invention, whose scope is to be limited only by the claims, below.

### REFERENCES

1. Ash, A. A., Eisen, M. B., Davis, R. E., Ma, C., Lossos, I. S., Rosenwald, A., Broldrick, J. C., Sabet, H. Tran, T., Yu, X., Powell, J. I., Yang, L., Marti, G. E., Moore, T., Hudson, J. Jr., Lu, L., Lewis, D. B., Tibshirani, R., Sherlock, G., Chan, W. C., Greiner, T. C., Weisenburger, D. D. Armitage, J. O., Warnke, R., Levy, R., Wilson, W., Grever, M. R., Byrd, J. C., Botstein, D., Brown, P. O., Staudt, L. M. (2000), “Distinct Types of Diffuse Large B-Cell Lymphoma Identified by Expression Profiling,” Nature, 403, 503-511.

2. Alon, U., Barkai, N., Notterman, D. A., Gish, K., Ybarra, S., Mack, D., Levine, A. J. (1999), “Broad Patterns of Gene Expression Revealed by Clustering Analysis of Tumor and Normal Colon Tissues Probed by Oligonucleotide Arrays,” Proceedings of the National Academy of Sciences, 96, 6745-6750.

3. Chen, Y., Dougherty, E. R., and Bittner, M. L. (1997), “Ratio-Based Decisions and the Quantitative Analysis of cDNA Microarray Images,” Journal of Biomedical Optics, 2(4), 364-374.

4. DeRisi, J., Penland, L., Brown, P. O., Bittner, M. L., Meltzer, P. S., Ray, M., Chen, Y., Su, Y. A. and Trent, J. M. (1996) “Use of cDNA Microarray to Analyse Gene Expression Patterns in Human Cancer,” Nature Genetics, 14, 457-460.

5. Eisen, M. B., Spellman, P. T., Brown, P. O., and Botstein, D. (1998), “Cluster Analysis and display of Genome-Wide Expression Patterns,” Proceedings of the National Academy of Sciences, 95(25), 14863-14868.

6. Ermolaeva, O., Rastogi, M., Pruitt, K. D., Schuler, G. D., Bittner, M. L., Chen, Y., Simon, R., Meltzer, P., Trent, J. M., and Boguski, M. S. (1998), “Data Management and Analysis for Gene Expression Arrays,” Nature Genetics, 20, 19-23.

7. Golub, T. R., Slonim, D. K., Tamayo, P., Huard, C., Gaasenbeek, M., Mesirov, P., Collerk H., Loh, M. L., Downing, J. R., Caligiuri, M. A., Bloomfield, C. D., and Lander, E. S. (1999), “Molecular Classification of Cancer: Class Discovery and Class Prediction by Gene Expression Monitoring,” Science, 286, 531-537.

8. Hilsenbeck, S. G., Friedrichs, W. E., Schiff, R., O'Connell, P., Hansen, R. K., Osborne, C. K. and Fuqua, S. A. (1999), “Statistical Analysis of Array Expression Data as Applied to the Problem of Tamoxifen Resistance,” J. Natl. Cancer Inst., 91(5), 453-459.

9. Newton, M. A., Kendziorski, C. M., Richmond, C. S., Blattner, F. R., and Tsui, K. W., (2000), in press Journal of Computational Biology.

10. Rock, D. M., and Lorenzato, S. (1995), “A Two-Component Model for Measurement Error in Analytical Chemistry,” Technometrics, 37(2), 176-184.

11. Ross, D. T., Scherf, U., Eisen, M. B., Perou, C. M., Rees, C., Spellman, P., Iyer, V., Jeffrey, S. S., Rijin, M. V., Waltham, M., Pergamenschikov, A., Lee, J., Lashkari, D., Shalon, D., Myers, T. G., Weinstein, J. N., Botstein, D., and Brown, P. O. (2000), “Systematic Variation in Gene Expression Patterns in Human Cancer Cell Lines,” Nature Genetics, 24, 227-235.

What is claimed is:

1. A method for estimating the precision of measurements taken from an array, comprising:
(a) identifying a set of low-level data measurements;
(b) estimating a standard deviation, σ_{ε} of an additive error component, ε;
(c) estimating a background parameter,α;
(d) identifying a set of replicated high-level data measurements;
(e) estimating a standard deviation, σ_{η}, from the standard deviation of the logarithm of the replicated high-level data set;
(f) measuring a signal, y, wherein said signal indicates an amount of a biological molecule; and
(g) estimating a variance of the measured signal as
Vâr(\hat{μ})=\hat{σ}_{ε}²+\hat{μ}²e^{\hat{σ}}^{_{η}}^{²}(e^{\hat{σ}}^{_{η}}^{²}−1), where \hat{μ}²=(y−α)².

2. The method of claim 1, wherein said identifying step (a) comprises the use of a thresholding algorithm to establish a cutoff, and the set of low-level data consists of those data with values less than the cutoff.

3. The method of claim 2, wherein the thresholding algorithm comprises the steps of:
(a) identifying A_{N}, an initial set of low-level data measurements consisting of q percent of the total number of data points having the lowest measurement values, A_{N}={x₁, x₂, . . . , xₙₒ};
(b) calculating a mean and a standard deviation of the initial set;
(c) calculating a cutoff point, u_{N}=mean plus c× the standard deviation, wherein 2≦c≦3;
(d) defining a new set, A_{N+1}={xⱼ<u_{N}};
(e) calculating a mean and standard deviation of the new set; and
(f) repeating steps (c) and (d) using the mean and standard deviation of the new set until the algorithm converges.

4. The method of claim 2, wherein the thresholding algorithm comprises the steps of:
(a) identifying A_{N}, an initial set, of low-level data consisting of q percent of the total number of data points having the lowest measurement values, A_{N}={x₁, x₂, . . . , xₙₒ};
(b) calculating a median of the initial set, mₒ=median {xⱼ}ⱼ₌₁ⁿ_{^{o}} and a median of the absolute deviations about the median, MAD₀=median {|xⱼ−mₒ|}ⱼ₌₁ⁿ_{^{o}};
(c) calculating a cutoff point, u₀=MAD₀+c×sₒ, wherein sₒ=MAD₀/0.675 and 2≦c≦3;
(d) defining a new set, A_{N+1}={xⱼ<u_{N}};
(e) calculating a median and a median of the absolute deviations about the median of the new set; and
(f) repeating steps (c) and (d) using the median and the median of the absolute deviations about the median of the new set until the algorithm converges.

5. The method of claim 2, wherein the mean of the low-level data measurements is used as the estimate of the background parameter, α.

6. The method of claim 1, wherein the standard deviation of the low-level data measurementsis used as the estimate of the parameter σ_{ε}.

7. The method of claim 1, wherein, a mean of negative control data is used as the estimate of the background parameter, α.

8. The method of claim 1, wherein the biological molecule is a nucleic acid.

9. The method of claim 8, wherein the nucleic acid is mRNA.

10. The method of claim 8, wherein the biological molecule is DNA.

11. The method of claim 10, wherein the DNA is cDNA.

12. The method of claim 10, wherein the DNA is genomic.

13. The method of claim 1, wherein the biological molecule is a protein.

14. The method of claim 1, wherein the biological molecule is a lipid.
